(19) United States
(12) Patent Application Publication
(10) Pub. No.: US 2013/0186820 A1
(43) Pub. Date: Jul. 25, 2013

(54) FILTRATION SYSTEM

(71) Applicant: Ron Tal, Kibbutz Shamir (IL)

(72) Inventor: Ron Tal, Kibbutz Shamir (IL)

(21) Appl. No.: 13/877,459

(22) PCT Filed: Oct. 3, 2011
(86) PCT No.: PCT/US11/54537

§ 371 Date: Apr. 3, 2013

Related U.S. Application Data
(60) Provisional application No. 61/389,244, filed on Oct. 3, 2010.

(51) Int. Cl. B01D 33/48

(52) U.S. Cl. CPC B01D 33/48
USPC 210/332

(57) ABSTRACT

An innovative fiber-wound filtration system for use with spiral-trajectory type cleaning systems.

### FIELD OF THE INVENTION

The invention relates to the field of automated and semi-automated filtration systems, such as but not limited to, water filters with automated cleaning processes. Though the following description focuses on water filtration it should be evident to the person skilled in the art of filtration that the invention applies to filtration of all media.

### BACKGROUND OF THE INVENTION

All filtration systems are tasked with purifying some medium through separation of some suspended particles from the medium. Automated and semi-automated filtration systems include the filter element and a cleaning system. The cleaning system and the filter element are often conceived and engineered as a complete system with unique attributes that enhance the functionality of the system. This synergy between the filter element and the cleaning system often precludes the use of the filter element with a different cleaning system and vice versa.

The prior art in filter elements includes fiber-wound disposable elements whereby a porous blank is used as a base around which layers of wound fibers are added. The resulting element presents a maze that traps particles in the fiber. The filtration degree is controlled by the combination of: the number of wound layers, the winding tension, and the fibers properties such as material size and surface. Fiber-wound elements for non-automated filtration are typically cylindrical surfaces called “cartridges” in the professional jargon. Cartridges are non-renewable, disposable elements that make up for most of the fiber-wound filtration industry. In automated fiber-wound filtration, there are flat-shaped, rectangular elements that are placed linearly to form long flat surfaces. The result is a larger filtration surfaces that can be cleaned using a pressure jet head that is moved linearly along the surface.

In the prior art there are no fiber-wound elements that allow the formation of flat or semi-flat, disc-shaped filtration surfaces.

### SUMMARY OF THE INVENTION

The invention is directed to a fiber-wound filtration system for use with spiral-trajectory type cleaning systems. The two basic elements in the system are the filter element and the central filtrate conduit. The filter element utilizes multiple layers of fiber wound on a backing surface in a direction perpendicular to the backing's radial centerline. The element is shaped as part of a disc and multiple filter elements may constitute a complete disc surface with a circular or polygonal-shaped perimeter, hereafter referred to as the “Filter disc”. Filter discs formed by multiple filter elements may be stacked along the central filtrate conduit to form larger filtration surfaces, hereafter referred to as the “Filter stack”. Any number of filter stacks may be assembled to form a system of filter stacks. In such arrangements, each stack has its own central filtrate collection conduit. In the example illustrated, multiple filter stacks are evenly distributed about a center point, hereafter referred to as the “Cleaning System Rotation Center”.

### BRIEF DESCRIPTION OF THE DRAWINGS

The present invention will be understood and appreciated more fully from the following detailed description taken in conjunction with the drawings in which:

FIG. 1 is a simplified illustration of the general shape of the filter element backing and the direction in which the fiber is wound.

FIG. 2 is a simplified illustration of how multiple filter elements may be assembled to form filter discs, and how discs may be stacked and connected by a central filtrate conduit to form a filter stack.

FIG. 3 is a simplified illustration of how a multitude of disc stacks may be arranged about a centerline and combined with a central spiral-like cleaning mechanism.

FIG. 4 is a simplified illustration of an example of a backing with multiple filtrate collection zones, each with its own filtrate drain passage to backing's internal cavity.

FIG. 5 is a simplified illustration of the multi-contact point approach for securing the filter element, in accordance with an embodiment of the invention.

FIG. 6 is a simplified illustration of a sample setup to produce spiral-like cleaning head trajectory on the filter disc surface. In this example, disc stacks are cleaned sequentially as the cleaning heads are slowly advanced in a circular path while the stacks rotate at a much faster rate.

### DETAILED DESCRIPTION OF EMBODIMENTS

Though the following description focuses on a three stack, circular arrangement with a central cleaning head manifold, it should be clear that any number of stacks can be used with any cleaning manifold arrangement appropriate for a spiral-trajectory type cleaning system.

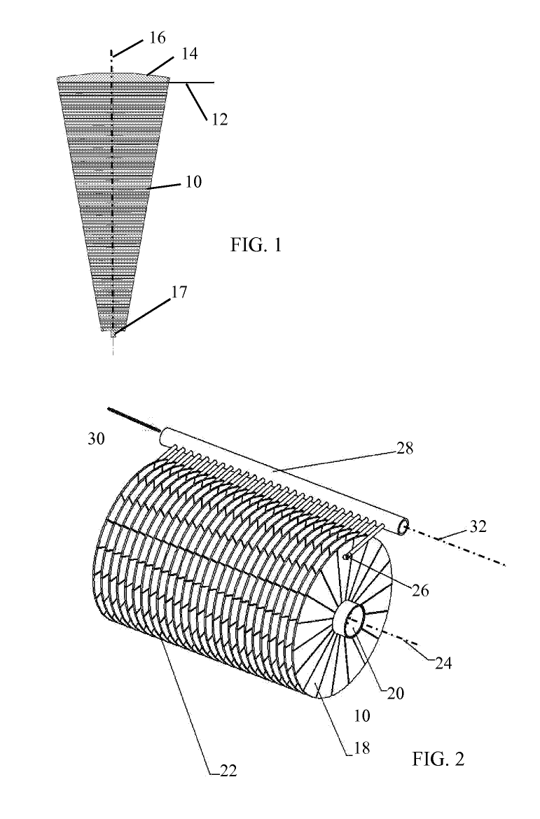

Reference is made to FIG. 1. A plurality of filter elements 10 comprise multiple layers of fiber 12 wound on a backing surface 14 in a direction perpendicular to the backing's radial centerline 16. There is a filter element filtration outlet 17.

Reference is made to FIG. 2. The element 10 is shaped as part of a disc and multiple filter elements 10 may constitute a complete disc surface with a circular or polygonal-shaped perimeter, hereafter referred to as a “Filter disc” 18. Filter discs 18 formed by multiple filter elements may be stacked along a central filtrate conduit 20 (also referred to as central filtrate collection conduit 20) to form larger filtration surfaces, hereafter referred to as the “Filter stack” 22. Any number of filter stacks may be assembled to form a system of filter stacks. In such arrangements, each stack has its own central filtrate collection conduit 20. In the example illustrated, multiple filter stacks are evenly distributed about a center point or axis, hereafter referred to as the “Cleaning System Rotation Center” 24. A plurality of cleaning heads 26 are in fluid communication with a manifold 28. Manifold 28 supplies cleaning fluid from a pressurized cleaning fluid supply 30 to cleaning heads 26. Manifold 28 rotates heads 26 about a longitudinal axis 32.

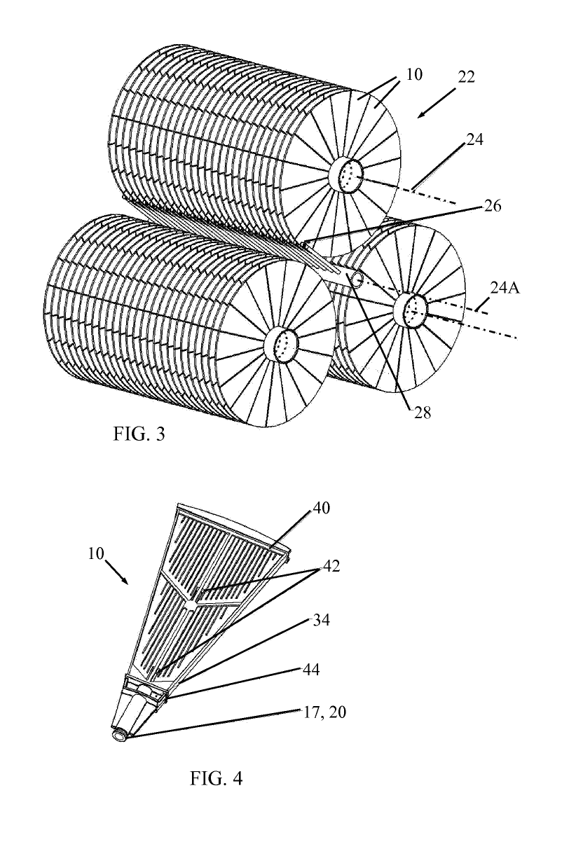

FIG. 3 illustrates another example of a multitude of disc stacks 22 arranged about a common centerline 24A and combined with a central spiral-like cleaning mechanism 26.

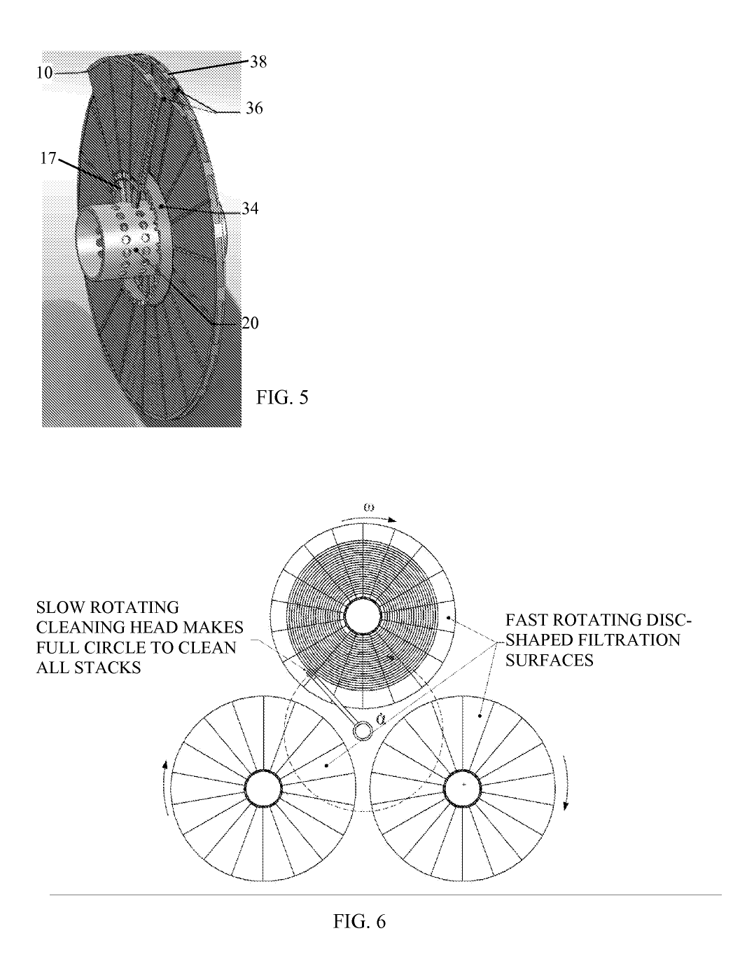

The effectiveness of cleaning head 26 is directly related to the distance from the filtration surface to be cleaned. In an embodiment of the invention, a multi-contact point approach is used to secure the filter element 10 laterally in order to minimize the distance between the cleaning head 26 and the filter element surface, as is now described with reference to FIG. 5.

One contact point is provided by inserting the filter element's outlet 17 into the central conduit 20 and another point is provided by a spacer-retaining ring 34, which secures the filter element 10 in place radially and laterally from both sides. Additional radial retention and elements alignment at the perimeter is achieved by a strap 36 in a groove 38. The resulting disc assembly is both rigid and secure. The flexible strap 36 provides added radial support and filter element alignment for close and contact-less rotation that results in significantly greater cleaning efficiency. Cleaning fluid flows into the central conduit 20 and out of the filter. The central conduit 20 also serves as a structural member to transmit rotational torque and hold the elements 10 rigidly in place.

In other words, the filter element's cylinder outlet 17 is inserted into a hole in the main collection conduit 20. While this serves to evacuate the filtrate from the filter element 10 into the main conduit and out of the filter, it also serves as a (first) lateral support. Additional lateral support is provided by spacer-retaining ring 34 pressing against the side of the element 10. As the distance is increased from the last lateral support so does the possibility that abutted filter elements in a disc may not align at the perimeter or go out of alignment during the cleaning process. In order to ensure alignment the invention incorporates a means to secure the elements at the perimeter of the disc. In FIG. 5 one possible solution is strap 36 secured in the groove 38 in the filter element's backing. The result is a tightly stacked rigid system which allows for close and contactless travel of the cleaning head during the cleaning process while increasing the number of filter discs that can be stacked in a given filter housing.

Reference is made to FIG. 4. In order to reduce hydraulic resistance the filter element 10 may include ribs 40 that form flow channels for the filtrate by supporting the fiber layers at some distance away from the backing surface. Though the best support is achieved when the ribs are placed perpendicularly to the fiber, such placement is not imperative. To further reduce resistance, element 10 includes multiple filtrate collection zones 42. Each collection zone 42 has multiple flow channels and a separate collection passage to the backing internal collection cavity. Water is filtered by passing through the maze formed by the fiber layers and the ribbed backing surface. The filtrate then flows in channels between the fiber and the backing surface, through at least one opening, and into at least one internal collection backing cavity. From the cavity the water flows through a central circular conduit into a manifold and out of the filter. In order to reduce the circular conduit's diameter while maintaining a high number of elements in the filter disc a single outlet is utilized in the filter element. The contact surface and spacer retaining ring 34 provide a (second) lateral support. Curved raised edge or edges 44 work with ring 34 to secure the element radially.

It is emphasized that there many possible system configurations for a spiral-trajectory type cleaning systems. The examples in FIGS. 2, 3, and 6 illustrate two possible arrangements of many. These examples are intended to clarify the utilization of the filter element in spiral-trajectory based applications. Though these examples show three filter stack arrangement with a central Cleaning System Rotation Center, it should be clear to the person skilled in the art that the example does not in any way limit the application of the filter element to the system design in the examples. In the examples the cleaning system is comprised of an array of cleaning heads, a means to deliver pressurized cleaning water, and a mechanical means to advance the cleaning heads in a spiral-like trajectory relative to the filter element surface to be cleaned. The cleaning heads are arranged in such a way that forced applied on the filter disc by water jet pressure are offset. Each cleaning head applies at least one water pressure jet to the filter disc surface with effective instantaneous cleaning area A_{E}. Each cleaning head is attached to the end of a rigid member that is hinged and rotates about the Cleaning System Rotation Center. As is the case in the illustrated examples, the rigid member may also serve to supply the cleaning heads with pressurized cleaning fluid. In other applications it may be advantageous to have a separate cleaning fluid supply by way of a flexible conduit. During the cleaning process the disc rotates at a much higher rate compared with the rotation of the cleaning head. The produced spiral-like relative trajectory combined with the effective cleaning area A_{E} result in complete coverage of the filter disc surface as seen FIG. 6.

1. A filtration system characterised by:
a plurality of filter elements comprising multiple layers of fiber wound on a backing surface in a direction perpendicular to the backing's radial centerline, and comprising a filter element filtration outlet, said filter elements forming a plurality of filter discs stacked along a conduit to form filter stacks distributed about a cleaning system rotation center; and
a plurality of cleaning heads in fluid communication with a manifold for directing flow of a cleaning fluid into said conduit and out of the system.

2. The filtration system according to claim 1, wherein said manifold rotates said cleaning heads, about a longitudinal axis.

3. The filtration system according to claim 1, wherein said filtration outlet is received in said conduit and a spacer-retaining ring secures said filter elements radially and laterally from both sides of said elements.

4. The filtration system according to claim 1, wherein a strap is inserted in a groove formed on a perimeter of said filter elements.

5. The filtration system according to claim 1, wherein said conduit is a central conduit that serves as a structural member to transmit rotational torque and hold said filter elements rigidly in place.

6. The filtration system according to claim 1, wherein each of said filter Elements comprises ribs that form flow channels by supporting fiber layers at a distance away from said backing surface.

7. The filtration system according to claim 1, wherein each of said filter elements comprises multiple filtrate collection zones.
